(19) United States
(12) Patent Application Publication
(10) Pub. No.: US 2026/0080839 A1
(43) Pub. Date: Mar. 19, 2026

(54) BACKLIGHT ADJUSTMENT METHOD AND APPARATUS

(71) Applicant: HONOR DEVICE CO., LTD., Shenzhen (CN)

(72) Inventor: Peixin Liu, Shenzhen (CN)

(21) Appl. No.: 19/402,630

(22) Filed: Nov. 26, 2025

Related U.S. Application Data
(63) Continuation of application No. PCT/CN2024/081006, filed on Mar. 11, 2024.

(30) Foreign Application Priority Data
Jul. 12, 2023 (CN) 202310855262.5

(51) Int. Cl. G09G 3/34; G09G 3/36

(52) U.S. Cl. CPC G09G 3/3406; G09G 3/36; G09G 2320/0247; G09G 2320/064

(57) ABSTRACT

An embodiment of this application provides a backlight adjustment method. The method includes: A terminal device first obtains an undelivered second backlight value before displaying an image. When the second backlight value is not equal to a first backlight value of the terminal device when a previous image frame is displayed, the terminal device replaces the second backlight value with a preset backlight value if the second backlight value is greater than the preset backlight value and the first backlight value is less than the preset backlight value or the second backlight value is less than the preset backlight value and the first backlight value is greater than the preset backlight value, and displays the image based on the preset backlight value, to add transition backlight during transition between a DC dimming strategy and a PWM dimming strategy.

### CROSS-REFERENCE TO RELATED APPLICATIONS

This application is a continuation of International Application No. PCT/CN2024/081006, filed on Mar. 11, 2024, which claims priority to Chinese Patent Application No. 202310855262.5, filed on Jul. 12, 2023, both of which are incorporated herein by reference in their entireties.

### TECHNICAL FIELD

This application relates to the field of terminal technologies, and in particular, to a backlight adjustment method and apparatus.

### BACKGROUND

With popularization and development of the Internet, people have increasingly diversified requirements on functions of terminal devices. For example, to meet use requirements of a user on a device screen, a terminal device may support backlight brightness adjustment, and a picture effect presented by the terminal device may better meet visual perception of the user through the backlight brightness adjustment.

Usually, to implement reasonable backlight adjustment, the terminal device may perform backlight adjustment by using a DC dimming strategy when the terminal device detects that backlight brightness is within a range from highest screen brightness to mid-low screen brightness. For example, a driving current flowing through an organic light-emitting material is reduced to control light-emitting efficiency, thereby adjusting the backlight brightness. The terminal device performs backlight adjustment by using a PWM dimming strategy when the terminal device detects that the backlight brightness is within a range from the mid-low screen brightness to lowest screen brightness. For example, the backlight brightness is adjusted by reducing a screen-on ratio, that is, a duty (duty) value. The highest screen brightness may be about 1000 nits or the like, the mid-low screen brightness may be about 70 nits or the like, and the lowest screen brightness may be about 2 nits or the like.

However, the foregoing backlight adjustment method may cause a problem of an abrupt change in screen brightness.

### SUMMARY

Embodiments of this application provide a backlight adjustment method and apparatus, to add transition backlight during transition between a DC dimming strategy and a PWM dimming strategy, so that a problem of an abrupt change in screen brightness can be alleviated, thereby implementing smooth transition of the screen brightness.

According to a first aspect, an embodiment of this application provides a backlight adjustment method. The method includes: A terminal device displays an nth image frame, where a backlight value of the terminal device is a first backlight value when the nth image frame is displayed; and the terminal device displays an (n+1)th image frame, where a backlight value of the terminal device is a preset backlight value when the (n+1)th image frame is displayed; the terminal device further obtains a second backlight value after displaying the nth image frame and before displaying the (n+1)th image frame, and when the second backlight value is not equal to the first backlight value, the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value, and displays the (n+1)th image frame based on the preset backlight value; and the preset backlight value belongs to a preset backlight interval, a minimum value of the preset backlight interval is a minimum backlight value that is allowed to be adjusted when backlight adjustment is performed by using a direct current DC dimming strategy, and a maximum value of the preset backlight interval is a maximum backlight value that is allowed to be adjusted when backlight adjustment is implemented by using a pulse width modulation PWM dimming strategy. In this way, the terminal device may add transition backlight during transition between the DC dimming strategy and the PWM dimming strategy, so that a problem of an abrupt change in screen brightness can be alleviated, thereby implementing smooth transition of the screen brightness.

The second backlight value may be a new backlight value described in the embodiments of this application, and the first backlight value may be a backlight value of a previous frame described in the embodiments of this application.

In a possible implementation, that the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value includes: The terminal device replaces the second backlight value with the preset backlight value if the second backlight value is not 0 and the first backlight value is not 0 and if the second backlight value is greater than the preset backlight value and the first backlight value is less than the preset backlight value or the second backlight value is less than the preset backlight value and the first backlight value is greater than the preset backlight value. In this way, the terminal device may further eliminate interference caused by a screen-off to screen-on scenario, a screen-on to screen-off scenario, and a screen-off scenario on the backlight adjustment method in a process of adding a transition backlight value.

In a possible implementation, the method further includes: The terminal device displays an interface based on the second backlight value if the second backlight value is 0 or the first backlight value is 0. In this way, the terminal device may directly deliver the second backlight value in the screen-off to screen-on scenario, the screen-on to screen-off scenario, and the screen-off scenario through scenario identification.

In a possible implementation, the method further includes: The terminal device buffers the second backlight value; and the terminal device displays an (n+2)th image frame, where a backlight value of the terminal device is the second backlight value when the (n+2)th image frame is displayed; and the terminal device further obtains a third backlight value after displaying the (n+1)th image frame and before displaying the (n+2)th image frame, and the terminal device buffers the third backlight value if the second backlight value is not 0, and displays the (n+2)th image frame based on the second backlight value. In this way, the terminal device may implement delayed backlight value delivery, so that a backlight value difference between any two frames is maintained in a stable range, and stable delivery of the backlight value is implemented, thereby ensuring that a picture displayed by the terminal device in a backlight adjustment process better meets visual perception of a user.

In a possible implementation, the terminal device includes: a liquid crystal display kit and a display driver integrated circuit, and that the terminal device replaces the second backlight value with the preset backlight value, and displays an interface based on the preset backlight value includes: The liquid crystal display kit replaces the second backlight value with the preset backlight value, and delivers the preset backlight value to the display driver integrated circuit; and the display driver integrated circuit delivers the preset backlight value to a display, and the display displays the interface based on the preset backlight value. In this way, the liquid crystal display kit provided in this embodiment of this application may store the preset backlight value, determine a value between the backlight value of a previous frame and the preset backlight value, and deliver the preset backlight value. Therefore, backlight transition between the DC dimming strategy and the PWM dimming strategy is implemented based on the added preset backlight value, thereby implementing the smooth transition of the screen brightness.

In a possible implementation, the terminal device further includes a DSI driver, and the method further includes: The liquid crystal display kit delivers a first feature value to the DSI driver; and the DSI driver does not deliver the second backlight value based on the first feature value. In this way, the DSI driver may determine not to deliver the second backlight value based on the first feature value, thereby reducing direct delivery of the second backlight value by the DSI driver.

In a possible implementation, the terminal device includes: a liquid crystal display kit, a DSI driver, and a display driver integrated circuit, and that the terminal device displays an interface based on the second backlight value if the second backlight value is 0 or the first backlight value is 0 includes: The liquid crystal display kit delivers a second feature value to the DSI driver if the liquid crystal display kit determines that the second backlight value is 0 or the first backlight value is 0; the DSI driver delivers the second backlight value to the display driver integrated circuit based on the second feature value; and the display driver integrated circuit delivers the second backlight value to a display, and the display displays the interface based on the second backlight value. In this way, the DSI driver may determine to deliver the second backlight value based on the second feature value, thereby maintaining existing backlight delivery logic.

In a possible implementation, the terminal device is a terminal device supporting a high-frequency PWM dimming strategy of 3840 Hz.

According to a second aspect, an embodiment of this application provides a backlight adjustment apparatus. The apparatus includes: a processing module and a display module. The display module is configured to display an nth image frame and display an (n+1)th image frame. The processing module is configured to: when a second backlight value is not equal to a first backlight value, replace the second backlight value with a preset backlight value if the second backlight value is greater than the preset backlight value and the first backlight value is less than the preset backlight value or the second backlight value is less than the preset backlight value and the first backlight value is greater than the preset backlight value. The display module is further configured to display an interface based on the preset backlight value, where the preset backlight value belongs to a preset backlight interval, a minimum value of the preset backlight interval is a minimum backlight value that is allowed to be adjusted when backlight adjustment is performed by using a direct current DC dimming strategy, and a maximum value of the preset backlight interval is a maximum backlight value that is allowed to be adjusted when backlight adjustment is implemented by using a pulse width modulation PWM dimming strategy.

According to a third aspect, an embodiment of this application provides a terminal device, including a processor and a memory. The memory is configured to store code instructions, and the processor is configured to run the code instructions, so that the terminal device is enabled to perform the method according to the first aspect or any implementation of the first aspect.

According to a fourth aspect, an embodiment of this application provides a computer-readable storage medium. The computer-readable storage medium stores instructions, and when the instructions are executed, a terminal device is enabled to perform the method according to the first aspect or any implementation of the first aspect.

According to a fifth aspect, a computer program product is provided, including a computer program, where when the computer program is run, a terminal device is enabled to perform the method according to the first aspect or any implementation of the first aspect.

It should be understood that the technical solutions of the third aspect to the fifth aspect of this application correspond to the technical solutions of the first aspect of this application, and beneficial effects achieved by the aspects and corresponding feasible implementations are similar. Details are not described herein again.

### BRIEF DESCRIPTION OF DRAWINGS

FIG. 1A, FIG. 1B, FIG. 1C, and FIG. 1D are a schematic diagram of a scenario according to an embodiment of this application;

FIG. 2 is a schematic diagram of a hardware structure of a terminal device according to an embodiment of this application;

FIG. 3 is a schematic diagram of a software structure of a terminal device according to an embodiment of this application;

FIG. 4 is a schematic flowchart of a backlight adjustment method according to an embodiment of this application;

FIG. 5 is a schematic diagram of a backlight curve according to an embodiment of this application;

FIG. 6 is a schematic diagram of module interaction in a backlight adjustment method according to an embodiment of this application;

FIG. 7 is a schematic flowchart of another backlight adjustment method according to an embodiment of this application;

FIG. 8 is a schematic diagram of another backlight curve according to an embodiment of this application;

FIG. 9 is a schematic diagram of module interaction in another backlight adjustment method according to an embodiment of this application;

FIG. 10 is a schematic diagram of a structure of a synchronous playing apparatus according to an embodiment of this application; and

FIG. 11 is a schematic diagram of a hardware structure of another terminal device according to an embodiment of this application.

### DESCRIPTION OF EMBODIMENTS

To clearly describe the technical solutions in embodiments of this application, terms mentioned in the embodiments of this application are explained as follows:

### 1. Direct Current (Direct Current, DC)

In the display field, the DC represents a method of controlling brightness by manipulating a current or voltage flowing through a light-emitting unit.

In a stage in which a terminal device implements backlight control based on a DC dimming strategy, a screen-on ratio, that is, a duty value, may usually be a fixed value.

### 2. Pulse Width Modulation (Pulse Width Modulation, PWM)

In the display field, the PWM represents a method of controlling brightness by adjusting an on/off state ratio (duty) of the light-emitting unit.

In a stage in which the terminal device implements backlight control based on a PWM dimming strategy, a current or voltage of the light-emitting unit may usually be a fixed value.

It may be understood that when a rapidly changing image is seen, the rapidly changing image is processed into a smooth image because of a persistence of vision effect of a human eye. Therefore, the terminal device may control an on/off ratio of a screen to reduce a brightness integral value per unit time, thereby reducing brightness. In the stage of implementing the backlight control based on the PWM dimming strategy, visible brightness of the screen to the human eyes decreases as a screen-on ratio decreases.

### 3. Pulse (Pulse)

The pulse may be a basic constituent unit of PWM adjustment. Within a unit time, more pulses indicate a lower screen-on ratio in a scenario in which pulse widths are the same. Within a unit time, a larger pulse width indicates a lower screen-on ratio when a quantity of pulses is constant.

### 3. Duty (Duty)

A duty value may be used to refer to the screen-on ratio. A larger duty value indicates a larger screen-on ratio and higher screen brightness; and a smaller duty value indicates a smaller screen-on ratio and lower screen brightness.

### 4. Low Temperature Poly-Silicon (Low Temperature Poly-Silicon, LTPS)

The LTPS is a type of thin film transistor (thin film transistor, TFT) technology. A screen driven by the LTPS has advantages such as a fast response speed, high resolution, and low power consumption. Therefore, the screen driven by the LTPS is widely used by screen manufacturers.

### 5. Low Temperature Polysilicon Oxide (Low Temperature Polysilicon Oxide, LTPO)

The LTPO corresponds to the LTPS. Compared with the LTPS-TFT technology, an LTPO technology uses an oxide TFT to replace some LTPS TFTs with large leakage currents, where an LTPS TFT with high mobility drives an OLED, and the oxide TFT is configured to control a switch circuit. Carrier mobility of the LTPO technology is higher, so that a size of a gate driver circuit can be reduced, thereby implementing high resolution of a screen, and reducing a driving voltage to implement lower power consumption. In addition, a leakage current of the LTPO is low, further enabling reduction in screen power consumption and enabling the screen to operate at a lower screen refresh rate, for example, 10 Hz and 1 Hz. These refresh rates cannot be implemented by the LTPS-TFT technology.

### 6. Organic Light-Emitting Diode (Organic Light-Emitting Diode, OLED)

Currently, mainstream medium-and high-end models generally use a screen that is made of an OLED material. Compared with an LED screen, the OLED screen has advantages such as low brightness, no light leakage, high contrast, and high color resolution.

### 7. Display Driver Integrated Circuit (Display Driver IC, DDIC)

The DDIC is usually matched with a screen module, and is configured to customize a power supply setting and a timing setting of a screen panel and support decompression of a display data stream and transmission of the display data stream to the panel for display. Generally, a screen driver technology refers to receiving a signal sent by a system on chip (system on chip, SOC) through a mobile industry processor interface (mobile industry processor interface, MIPI) or another bus, decoding the signal, re-encoding/modulating/mapping the signal into a data stream according to a feature of a specific display device, converting the data stream into dynamic voltages by a 6/8/10-bit digital-to-analog converter (DAC) (one set for each of red, green, and blue), and charging corresponding TFTs or other gate control capacitors with the dynamic voltages through a mux switch under the control of horizontal synchronization signals (related to a frame rate and resolution).

### 8. Screen-Off and Screen-On

Screen-off may be understood as powering off a display screen of the terminal device. When the terminal device is screen-off, brightness of the display screen of the terminal device is less than preset brightness. Screen-on may be understood as powering on the display screen of the terminal device. When the terminal device is screen-on, the brightness of the display screen of the terminal device is higher than the preset brightness. Power-on may be understood as a current greater than a preset current value, and power-off may be understood as a current less than the preset current value.

For example, it may be understood that the terminal device is in a screen-off state when a backlight value of the terminal device is 0.

### 9. Terminal Device

The display screen of the terminal device described in embodiments of this application may be a screen that carries a 3840-Hz high-frequency PWM dimming feature and supports an LTPO feature. An eye protection screen with 3840-Hz high-frequency PWM dimming may be an eye protection screen with zero-risk dimming, and the screen is TÜV Rheinland flicker-free certified.

As defined in the Institute of Electrical and Electronics Engineers (Institute of Electrical and Electronics Engineers, IEEE) standard 1789-2015 regarding a correlation between a flicker risk level and a flicker frequency, a higher frequency indicates a lower flicker and less harm to human eyes. A frequency of 1250 Hz indicates a low-risk level, and a dimming frequency higher than 3125 Hz indicates a flicker-free hazard level. Therefore, the display screen mentioned in the embodiments of this application may be a screen with LTPO features that reaches the flicker-free hazard level.

It may be understood that on/off of a pixel unit actually refers to charging/discharging the light-emitting unit through the switch circuit. For an OLED screen with a high-frequency PWM solution, especially a screen using the LTPO technology, to maintain brightness at a lower frame rate without jittering, pixel charging of the OLED screen needs to be more adequate, and pulse charging time of the OLED screen needs to be met.

In the embodiments of this application, words such as “first” and “second” are used to distinguish between same items or similar items with basically same functions and effects. For example, a first value and a second value are merely used to distinguish between different values, but not used to limit a sequence thereof. A person skilled in the art may understand that the words such as “first” and “second” do not limit a quantity or an execution sequence, and the words such as “first”and “second”do not define a definite difference.

It should be noted that in this application, words such as “example” or “for example” are used to represent giving an example, an illustration, or a description. Any embodiment or design solution described as “example” or “for example” in this application should not be construed as being preferred or advantageous over other embodiments or design solutions. Exactly, the words such as “example”or “for example”are intended to present related concepts in a specific manner.

In this application, “at least one” means one or more, and “a plurality of” means two or more. “And/Or” describes an association relationship between associated objects, and represents that three relationships may exist. For example, “A and/or B” may represent the following cases: Only A exists, both A and B exist, and only B exists, where A and B may be singular or plural. The character “/” usually indicates an “or” relationship between associated objects. “At least one of the following items” or a similar expression thereof means any combination of these items, including a single item or any combination of a plurality of items. For example, at least one of a, b, or c may represent a, b, c, a and b, a and c, b and c, or a, b, and c, where a, b, and c may be singular or plural.

Usually, to implement reasonable backlight adjustment, the terminal device may perform backlight adjustment by using a DC dimming strategy when the terminal device detects that backlight brightness is within a range from highest screen brightness to mid-low screen brightness. For example, a driving current flowing through an organic light-emitting material is reduced to control light-emitting efficiency, thereby adjusting the backlight brightness. The terminal device performs backlight adjustment by using a PWM dimming strategy when the terminal device detects that the backlight brightness is within a range from the mid-low screen brightness to lowest screen brightness. For example, the backlight brightness is adjusted by reducing a screen-on ratio, that is, a duty (duty) value.

The PWM dimming strategy is used because of poor panel uniformity of an OLED screen at an extremely low current, which may cause abnormal display problems such as a mura (mura). Therefore, in the PWM dimming strategy, a current value may be fixed, but the screen-on ratio is reduced, that is, the duty value is reduced, to adjust the backlight brightness.

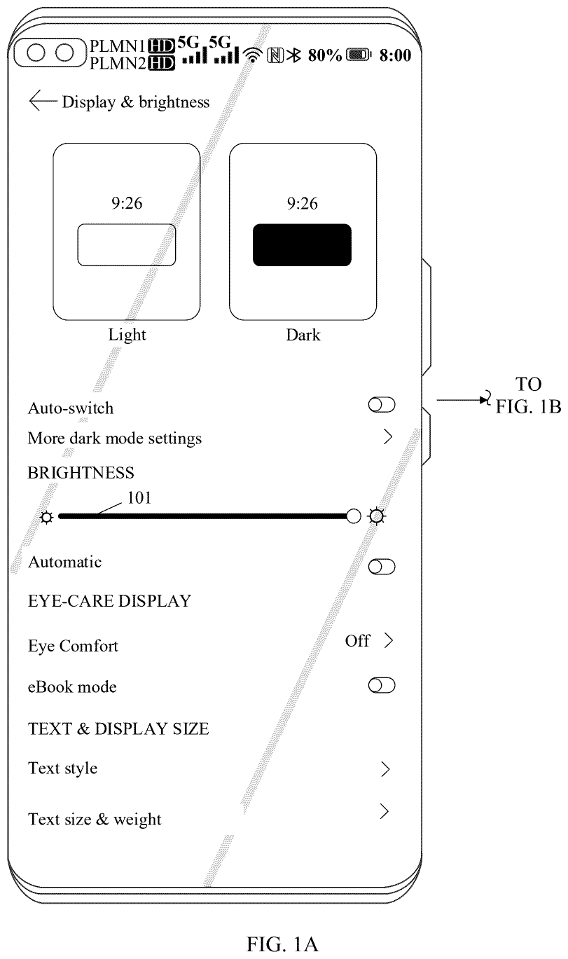

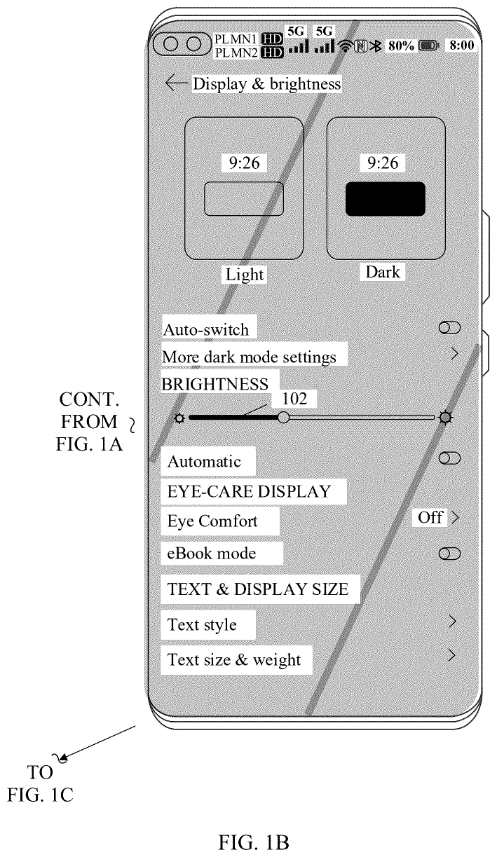

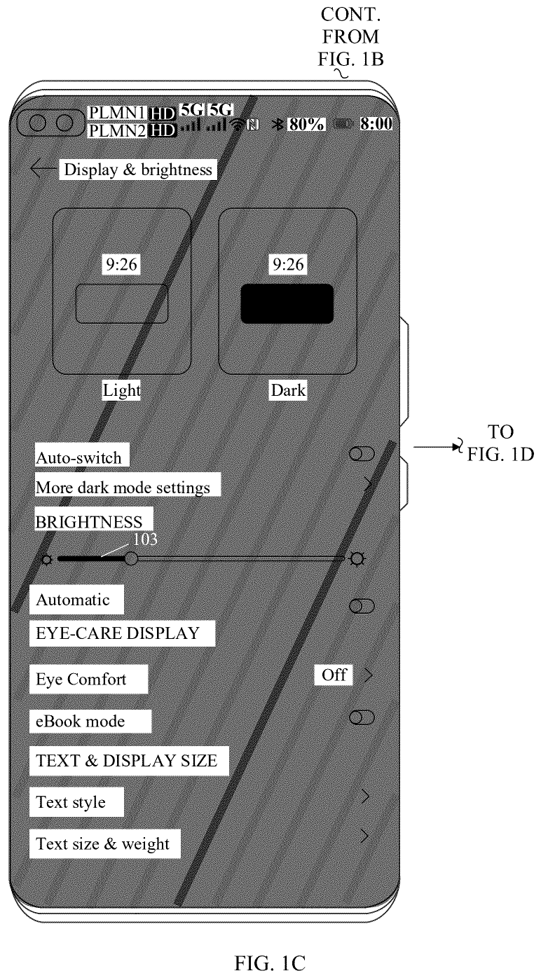

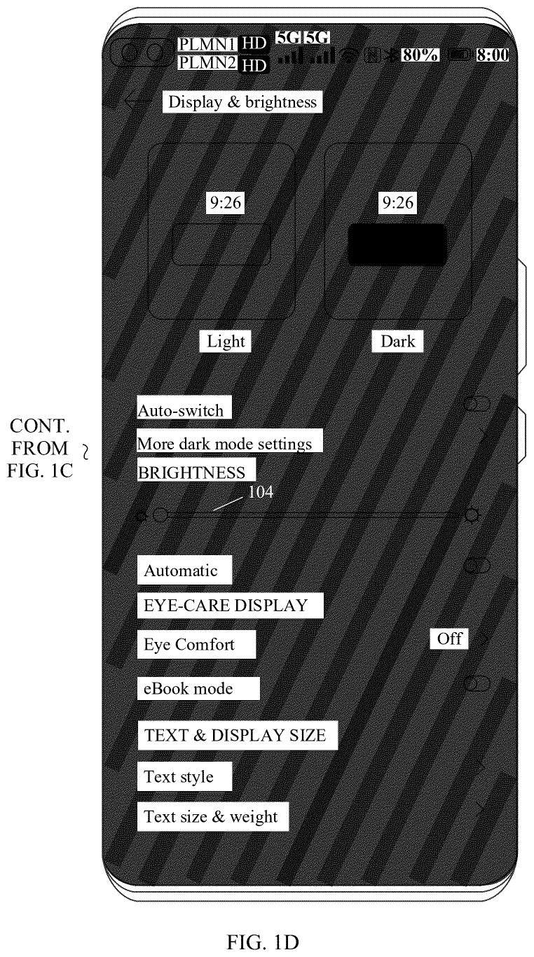

For example, a scenario in which embodiments of this application are applied is described with reference to an embodiment corresponding to FIG. 1A, FIG. 1B, FIG. 1C, and FIG. 1D. FIG. 1A, FIG. 1B, FIG. 1C, and FIG. 1D are a schematic diagram of a scenario according to an embodiment of this application. In the embodiment corresponding to FIG. 1A, FIG. 1B, FIG. 1C, and FIG. 1D, an example in which a terminal device is a mobile phone is used for description. This example does not constitute a limitation on this embodiment of this application.

It may be understood that any display picture in FIG. 1A, FIG. 1B, FIG. 1C, and FIG. 1D may be obtained by photographing a display screen of the terminal device by using a high-speed camera.

In response to backlight brightness of the terminal device changing from high to low, the terminal device may sequentially display a picture shown in FIG. 1A, a picture shown in FIG. 1B, a picture shown in FIG. 1C, and a picture shown in FIG. 1D.

FIG. 1A may show a picture displayed by the terminal device when the terminal device performs backlight adjustment based on a DC dimming strategy in a case that the backlight brightness is first brightness, and the first brightness may be brightness indicated when a brightness progress bar is at 101. FIG. 1B may show a picture displayed by the terminal device when the terminal device performs backlight adjustment based on the DC dimming strategy in a case that the backlight brightness is second brightness, and the second brightness may be brightness indicated when a brightness progress bar is at 102. A flicker in the picture shown in FIG. 1A and in the picture shown in FIG. 1B may correspond to a pulse in the DC dimming strategy. The first brightness is greater than the second brightness.

FIG. 1C may show a picture displayed by the terminal device when the terminal device performs backlight adjustment based on a PWM dimming strategy in a case that the backlight brightness is third brightness, and the third brightness may be brightness indicated when a brightness progress bar is at 103. FIG. 1D may show a picture displayed by the terminal device when the terminal device performs backlight adjustment based on the PWM dimming strategy in a case that the backlight brightness is fourth brightness, and the fourth brightness may be brightness indicated when a brightness progress bar is at 104. A flicker in the picture shown in FIG. 1C and in the picture shown in FIG. 1D may correspond to a pulse in the PWM dimming strategy, and a width of any pulse in the picture shown in FIG. 1C may be less than a width of any pulse in the interface shown in FIG. 1D. The second brightness is greater than the third brightness, and the third brightness is greater than the fourth brightness.

It may be determined by testing the picture shown in FIG. 1B that a duty value of the display screen may be 98.3%. It may be determined by testing the picture shown in FIG. 1C that a duty value of the display screen may be 58%.

It may be understood that the duty value of the display screen may be abruptly changed from 98.3% to 58% during transition between the DC dimming strategy and the PWM dimming strategy. In this case, a user subjectively feels a flicker problem due to the abrupt change in the backlight brightness.

Specifically, a reason why the backlight brightness of the terminal device cannot be smoothly transitioned between the DC dimming strategy and the PWM dimming strategy may be that the current DC dimming strategy and PWM dimming strategy do not perform the backlight adjustments in a manner of traversing backlight brightness levels, but perform the backlight adjustments in a stepped manner. For example, the terminal device may deliver a backlight value in the stepped manner according to a plurality of preset backlight values when the terminal device detects that the backlight value changes. The delivered backlight value may be a display brightness value (display brightness value, DBV) of backlight, and there is a one-to-one correspondence between the DBV and nit.

An example in which the delivered backlight value is the DBV is used for description. For example, the terminal device may sequentially deliver DBVs such as 1210, 1204, 1199, 1193, 1186, 1181, 1176, 1171, 1164, 1162, 1159, 1153, 1147, and 1140 based on a preset rule and a gradual change situation of the backlight brightness. When the terminal device determines that a DBV used for transition between the DC dimming strategy and the PWM is 1183, the terminal device can only deliver values such as 1186 and 1181 because the terminal device can only deliver the backlight based on the preset DBVs. In processes of delivering 1186 and 1181, there may be a problem of an abrupt change in a screen-on ratio.

It may be understood that the terminal device hardly has the problem of an abrupt change in a screen-on ratio if the backlight brightness of the terminal device may be delivered one by one in the manner of traversing the backlight brightness levels, for example, backlight values such as 1210, 1209, 1208, and 1207 are delivered one by one.

In view of this, an embodiment of this application provides a backlight adjustment method, to add transition backlight (or understood as delivering a preset backlight value) during transition between backlight adjustment performed by a terminal device based on a DC dimming strategy and backlight adjustment performed by the terminal device based on a PWM dimming strategy, thereby implementing smooth transition of a screen-on ratio.

The preset backlight value meets a preset backlight interval, a minimum value of the preset backlight interval is a minimum backlight value that is allowed to be adjusted when the backlight adjustment is performed by using the direct current DC dimming strategy, and a maximum value of the preset backlight interval is a maximum backlight value that is allowed to be adjusted when the backlight adjustment is implemented by using the pulse width modulation PWM dimming strategy. For example, the preset backlight value may be any backlight value in the preset backlight interval, for example, the preset backlight value may be a median of the preset backlight interval.

It may be understood that the terminal device may also be referred to as a terminal (terminal), user equipment (user equipment, UE), a mobile station (mobile station, MS), a mobile terminal (mobile terminal, MT), and the like. The terminal device may be a mobile phone (mobile phone) with a touchscreen, a smart TV, a wearable device, a tablet computer (Pad), a computer with a wireless sending/receiving function, a virtual reality (virtual reality, VR) terminal device, an augmented reality (augmented reality, AR) terminal device, a wireless terminal in industrial control (industrial control), a wireless terminal in self-driving (self-driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. A specific technology and a specific device form that are used by the terminal device are not limited in the embodiments of this application.

Therefore, to better understand the embodiments of this application, the following describes a structure of the terminal device in the embodiments of this application. For example, FIG. 2 is a schematic diagram of a structure of a terminal device according to an embodiment of this application.

The terminal device may include a processor 110, an external memory interface 120, an internal memory 121, a universal serial bus (universal serial bus, USB) interface 130, a charging management module 140, a power management module 141, an antenna 1, an antenna 2, a mobile communication module 150, a wireless communication module 160, an audio module 170, a speaker 170A, a receiver 170B, a microphone 170C, a headset jack 170D, a sensor module 180, a key 190, an indicator 192, a camera 193, a display screen 194, and the like.

The sensor module 180 may include one or more of the following: a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, or the like (not shown in FIG. 2).

It may be understood that the structure shown in the embodiments of this application does not constitute a specific limitation on the terminal device. In some other embodiments of this application, the terminal device may include more or fewer components than those shown in the figure, or combine some components, or split some components, or have different component arrangements. The components shown in the figure may be implemented by hardware, software, or a combination of software and hardware.

The processor 110 may include one or more processing units. Different processing units may be independent devices, or may be integrated into one or more processors. A memory may be further disposed in the processor 110 to store instructions and data.

The USB interface 130 is an interface that complies with USB standard specifications, and may be specifically a Mini USB interface, a Micro USB interface, a USB Type C interface, or the like. The USB interface 130 may be configured to be connected to a charger to charge the terminal device, may be configured to transmit data between the terminal device and a peripheral device, or may be configured to be connected to a headset to play audio through the headset. The interface may alternatively be configured to be connected to another electronic device, for example, an AR device.

The charging management module 140 is configured to receive a charging input from a charger. The charger may be a wireless charger or a wired charger. The power management module 141 is configured to be connected to the charging management module 140 and the processor 110.

A wireless communication function of the terminal device may be implemented by using the antenna 1, the antenna 2, the mobile communication module 150, the wireless communication module 160, a modem processor, a baseband processor, and the like.

The antenna 1 and the antenna 2 are configured to transmit and receive electromagnetic wave signals. The antenna in the terminal device may be configured to cover one or more communication bands. Different antennas may be further multiplexed to improve antenna utilization.

The mobile communication module 150 may provide a solution for wireless communication that is applied to the terminal device and that includes 2G/3G/4G/5G and the like. The mobile communication module 150 may include at least one filter, switch, power amplifier, low noise amplifier (low noise amplifier, LNA), and the like. The mobile communication module 150 may receive an electromagnetic wave by using the antenna 1, perform processing such as filtering or amplification on the received electromagnetic wave, and transmit a processed electromagnetic wave to the modem processor for demodulation.

The wireless communication module 160 may provide a solution for wireless communication that is applied to the terminal device and that includes a wireless local area network (wireless local area networks, WLAN) (for example, a wireless fidelity (wireless fidelity, Wi-Fi) network), Bluetooth (bluetooth, BT), a global navigation satellite system (global navigation satellite system, GNSS), frequency modulation (frequency modulation, FM), and the like.

The terminal device implements a display function by using the GPU, the display screen 194, the application processor, and the like. The GPU is a microprocessor for image processing, and is connected to the display screen 194 and the application processor. The GPU is configured to perform mathematical and geometric computing for graphics rendering.

The display screen 194 is configured to display an image, a video, and the like. The display screen 194 includes a display panel. In some embodiments, the terminal device may include one or N display screens 194, where N is a positive integer greater than 1.

The terminal device may implement a shooting function by using an ISP, the camera 193, a video codec, the GPU, the display screen 194, the application processor, and the like.

The camera 193 is configured to capture a still image or a video. In some embodiments, the terminal device may include one or N cameras 193, where N is a positive integer greater than 1.

The external memory interface 120 may be configured to be connected to an external memory card, for example, a Micro SD card, to expand a storage capacity of the terminal device. The external memory card communicates with the processor 110 through the external memory interface 120, to implement a data storage function, for example, to store files such as music and a video in the external memory card.

The internal memory 121 may be configured to store computer-executable program code, and the executable program code includes instructions. The internal memory 121 may include a program storage area and a data storage area.

The terminal device may implement an audio function, for example, music playing and recording, by using the audio module 170, the speaker 170A, the receiver 170B, the microphone 170C, the headset jack 170D, the application processor, and the like.

The audio module 170 is configured to convert digital audio information into an analog audio signal for output, and is further configured to convert an analog audio input into a digital audio signal. The speaker 170A, also referred to as a “loudspeaker”, is configured to convert an audio electrical signal into a sound signal. The terminal device may be used to listen to music or answer a call in a hands-free mode through the speaker 170A. The receiver 170B, also referred to as an “earpiece”, is configured to convert an audio electrical signal into a sound signal. When the terminal device receives a call or a voice message, the receiver 170B may be placed close to a human ear to receive the voice. The headset jack 170D is configured to be connected to a wired headset. The microphone 170C, also referred to as a “mic” or “mike”, is configured to convert a sound signal into an electrical signal. In the embodiments of this application, the terminal device may have one microphone 170C.

The pressure sensor is configured to sense a pressure signal, and may convert the pressure signal into an electrical signal. In some embodiments, the pressure sensor may be disposed on the display screen 194. The gyroscope sensor may be configured to determine a motion posture of the terminal device. The barometric pressure sensor is configured to measure barometric pressure. The magnetic sensor includes a Hall sensor. The acceleration sensor may detect magnitudes of accelerations in all directions (usually on three axes) of the terminal device. The distance sensor is configured to measure a distance. The optical proximity sensor may include, for example, a light-emitting diode (LED) and an optical detector, for example, a photodiode. The ambient light sensor is configured to sense ambient light brightness. The fingerprint sensor is configured to collect a fingerprint. The temperature sensor is configured to detect a temperature. The touch sensor is also referred to as a “touch control device”. The bone conduction sensor may obtain a vibration signal.

The touch sensor may be disposed on the display screen 194. The touch sensor and the display screen 194 constitute a touchscreen, which is also referred to as a “touch control screen”. In this embodiment of this application, a capacitive sensing node grid (hereinafter referred to as a capacitive sensor) may be disposed in the touchscreen. The terminal device may determine that a touch operation occurs when the terminal device determines that a value of a capacitance in at least one grid that is received by the capacitive sensor exceeds a capacitance threshold. Further, the terminal device may determine a touch area corresponding to the touch operation based on an area occupied by the at least one grid that exceeds the capacitance threshold.

The key 190 includes a power-on key, a volume key, or the like. The key 190 may be a mechanical key, or may be a touch key. The terminal device may receive a key input, and generate a key signal input related to user settings and function control of the terminal device. The indicator 192 may be an indicator light, may be configured to indicate a charging status or a power change, and may be further configured to indicate a message, a missed incoming call, a notification, and the like.

A software system of the terminal device may use a layered architecture, an event-driven architecture, a microkernel architecture, a microservice architecture, a cloud architecture, or the like. Details are not described herein again.

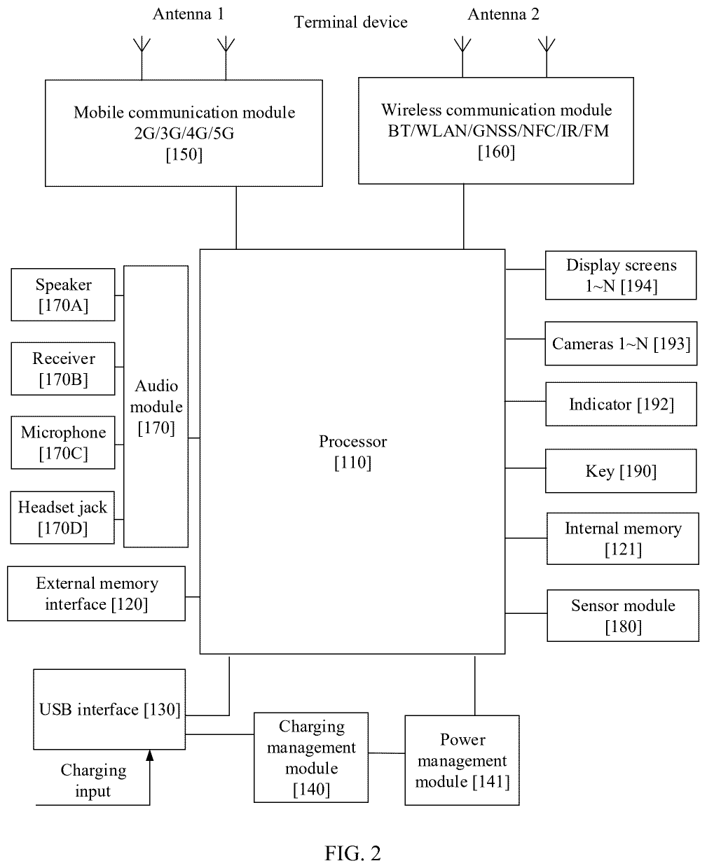

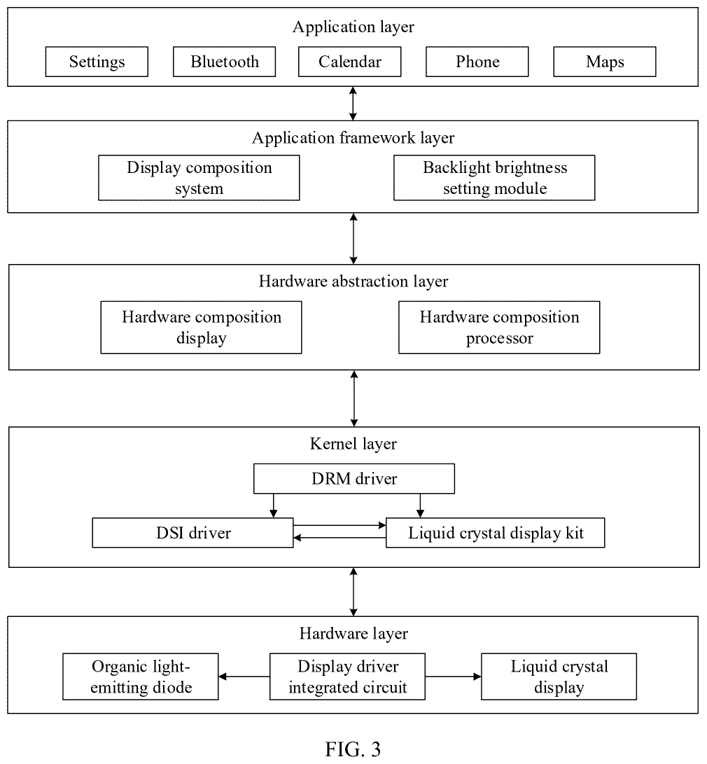

For example, FIG. 3 is a schematic diagram of a software structure of a terminal device according to an embodiment of this application. As shown in FIG. 3, the layered architecture divides software into several layers, and each layer has a clear role and task. Layers communicate with each other through a software interface. In some embodiments, an android system is divided into a plurality of layers from top to bottom: an application (application, APP) layer, an application framework (framework) layer, a hardware abstraction layer (hardware abstraction layer, HAL), a kernel (kernel) layer, a hardware (hardware) layer, and the like. This is not limited in this embodiment of this application.

The application layer may include a series of application packages. The application packages may include one or more of the following: Settings, Bluetooth, Calendar, Phone, Maps, or the like. This is not limited in this embodiment of this application.

The application framework layer provides an application programming interface (application programming interface, API) and a programming framework for the applications at the application layer. The application framework layer includes some predefined interfaces. The application framework layer may include one or more of the following: a display composition system (surface flinger), a backlight brightness setting module (framework backlight), or the like.

In this embodiment of this application, the display composition system is configured to composite received layer data, and is configured to deliver a frame rate of a device. For example, the display composition system may deliver the frame rate to a hardware composition processor or a hardware composition display when the display composition system detects that the frame rate changes.

The backlight brightness setting module is configured to deliver a backlight value. For example, the backlight brightness setting module may deliver a new backlight value to the hardware composition processor or the hardware composition display when the backlight brightness setting module detects that the backlight value changes.

In some embodiments, the application framework layer may include a window manager, a content provider, a resource manager, a view system, a notification manager, and the like (not shown in FIG. 3).

The window manager is configured to manage a window program. The window manager may obtain a size of a display screen, determine whether there is a status bar, lock a screen, touch a screen, drag a screen, capture a screenshot, and the like. The content provider is configured to store and obtain data, and enable the data to be accessible to an application. The data may include a video, an image, audio, calls that are made and answered, a browsing history and bookmarks, a phone book, and the like. The view system includes visual controls, for example, a control for displaying text and a control for displaying a picture. The view system may be configured to build an application. A display interface may include one or more views. For example, a display interface including an SMS message notification icon may include a view for displaying a text and a view for displaying a picture. The resource manager provides various resources for an application, for example, a localized string, an icon, a picture, a layout file, and a video file.

An objective of the hardware abstraction layer is to abstract hardware, so as to provide a unified interface for querying a hardware device for an upper-layer application, or provide a data storage service for an upper-layer application. The hardware abstraction layer may include one or more of the following: the hardware composition display (hardware display) or the hardware composition processor (hardware composer, HWC).

In this embodiment of this application, the hardware composition display or the hardware composition processor is configured to deliver an obtained backlight value or frame rate to a DRM (direct rendering manager) driver.

The kernel layer is a layer between hardware and software. The kernel layer is used to drive hardware, so that the hardware works. The kernel layer may include one or more of the following: the DRM driver, a display serial interface (display serial interface, DSI) driver, or a liquid crystal display kit (liquid crystal display kit, LCD kit).

The DRM driver may be a subsystem in a kernel. The DRM driver provides a mechanism that enables a user-space program to directly access graphics hardware. Main functions of the DRM is to manage resources of the graphics hardware, including a video memory, a command queue, an interruption, and the like, and to provide a set of APIs to enable the user-space program to interact with the graphics hardware.

In this embodiment of this application, the DRM driver is configured to transmit a value such as a received backlight value or frame rate to the DSI driver. The DSI driver is configured to transmit the value such as the backlight value or frame rate that is received from the DRM driver to the liquid crystal display kit. The liquid crystal display kit may preset a transition backlight value (or referred to as a preset backlight value), and determine whether to deliver the received backlight value based on the preset backlight value.

The hardware layer may include one or more of the following: an OLED, a DDIC, an LCD, or the like.

In this embodiment of this application, the DDIC is configured to convert the received backlight value into an electrical signal, and transmit the electrical signal to the OLED or the LCD through a mobile industry processor interface (mobile industry processor interface, MIPI).

With reference to the embodiment corresponding to FIG. 3, usually, a backlight delivery process may be as follows: The backlight brightness setting module may generate a new backlight value when the backlight brightness setting module detects that a backlight value changes, and deliver the new backlight value to the DRM driver by using the hardware composition processor or the hardware composition display. The DRM driver delivers the new backlight value to a display driver integrated circuit by using the DSI driver, and the display driver integrated circuit may convert the new backlight value into an electrical signal and deliver the electrical signal to a display such as the OLED or the LCD through the MIPI, so that the display can display an interface based on the new backlight value.

It may be understood that the software architecture provided in this embodiment of this application is merely an example, and the terminal device may also include another layer and/or module. This is not limited in this embodiment of this application.

The following describes in detail, by using specific embodiments, the technical solutions of this application and how to resolve the foregoing technical problem in the technical solutions of this application. The following several specific embodiments may be implemented independently, or may be combined with each other. For same or similar concepts or processes, details may not be described in some embodiments again.

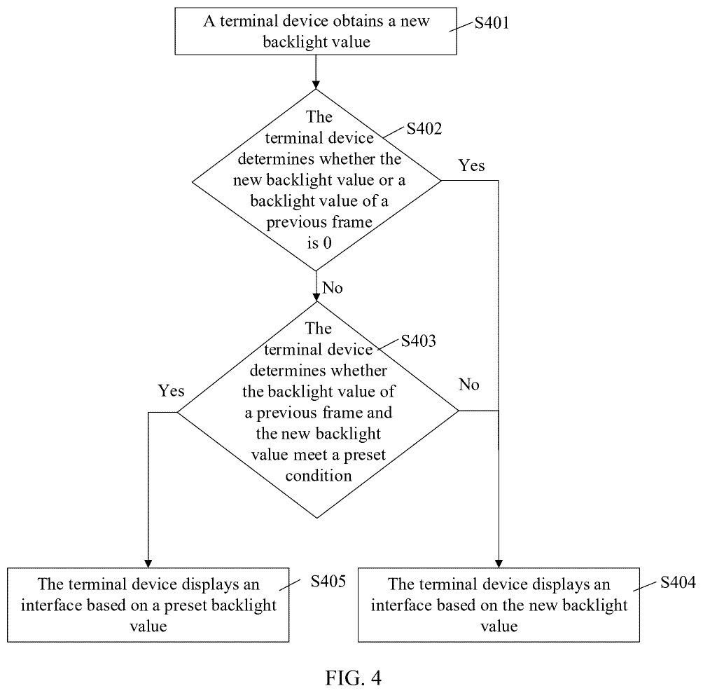

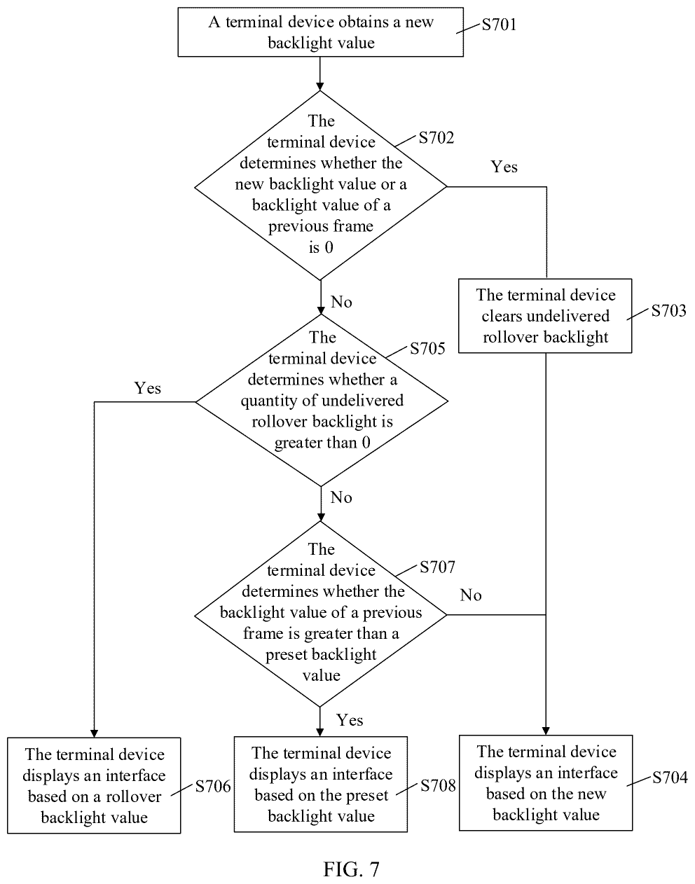

To resolve a problem of an abrupt change in screen brightness of a display screen that is caused during transition between a DC dimming strategy and a PWM dimming strategy, embodiments of this application may provide two backlight adjustment methods: A method 1 is a backlight replacement solution (refer to embodiments corresponding to FIG. 4-FIG. 6), and a method 2 is a backlight rollover solution (refer to embodiments corresponding to FIG. 7-FIG. 9).

### Method 1: Backlight Replacement Solution

In the backlight replacement solution, a terminal device may add a transition backlight value (or referred to as a preset backlight value) between a DC dimming strategy and a PWM dimming strategy to alleviate an abrupt change in screen brightness.

For example, FIG. 4 is a schematic flowchart of a backlight adjustment method according to an embodiment of this application. As shown in FIG. 4, the backlight adjustment method may include the following steps.

S401. A terminal device obtains a new backlight value.

The terminal device generates the new backlight value when the terminal device detects that a backlight value changes. The terminal device may determine that the backlight value changes when the terminal device detects that a user performs an operation of adjusting backlight brightness (for example, the embodiment corresponding to FIG. 1A, FIG. 1B, FIG. 1C, and FIG. 1D) or when the terminal device detects that brightness of ambient light changes by using a component such as an ambient light sensor, and generate the new backlight value.

S402. The terminal device determines whether the new backlight value or a backlight value of a previous frame is 0.

The backlight value of 0 may be understood as that a display screen is black or in a screen-off state. For example, it may be understood that the terminal device may switch from a screen-on state to the screen-off state when the backlight value of a previous frame is not 0 and the new backlight value is 0. In this scenario, the backlight value of a previous frame may be a value close to 0. It may be understood that the terminal device may switch from the screen-off state to the screen-on state when the backlight value of a previous frame is 0 and the new backlight value is not 0. In this scenario, the new backlight value may be a value close to 0. It may be understood that the terminal device is maintained in the screen-off state when the backlight value of a previous frame is 0 and the new backlight value is 0.

It may be understood that the terminal device performs backlight adjustment by using a PWM dimming strategy in a scenario in which the terminal device switches from the screen-on state to the screen-off state, switches from the screen-off state to the screen-on state, or is maintained in the screen-off state, and a problem of an abrupt change in a screen-on ratio does not exist in the backlight adjustment process. Therefore, the terminal device may ignore the case in which the new backlight value is 0 or the backlight value of a previous frame is 0.

In this embodiment of this application, the terminal device may perform a step shown in S404 when the terminal device determines that the new backlight value is 0 or the backlight value of a previous frame is 0, or the terminal device may perform a step shown in S403 when the terminal device determines that the new backlight value is not 0 and the backlight value of a previous frame is not 0.

For example, the terminal device may store a backlight value corresponding to each frame. When the terminal device does not deliver the new backlight value within a period of time, it may be understood that the backlight value does not change within the period of time, and a plurality of backlight values within the period of time may be the same.

S403. The terminal device determines whether the backlight value of a previous frame and the new backlight value meet a preset condition.

The preset condition may be that the backlight value of a previous frame is greater than a preset backlight value and the new backlight value is less than the preset backlight value, or the backlight value of a previous frame is less than a preset backlight value and the new backlight value is greater than the preset backlight value.

The preset backlight value may be understood as a transition backlight value between a DC dimming strategy and the PWM dimming strategy, and a value of the preset backlight value may be a value such as 1184.

In this embodiment of this application, the terminal device may perform a step shown in S405 when the terminal device determines that the backlight value of a previous frame and the new backlight value meet the preset condition or the terminal device may perform a step shown in S406 when the terminal device determines that the backlight value of a previous frame and the new backlight value do not meet the preset condition.

S404. The terminal device displays an interface based on the new backlight value.

For example, the terminal device may deliver the new backlight value to the display screen and buffer the new backlight value, and the display screen may display the interface based on the new backlight value. The terminal device may buffer a correspondence between a current frame and the new backlight value, and the correspondence buffered may be used in a subsequent backlight adjustment process.

S405. The terminal device displays an interface based on a preset backlight value.

For example, the terminal device may deliver the preset backlight value to the display screen and buffer the preset backlight value, and the display screen may display the interface based on the preset backlight value. The terminal device may buffer a correspondence between a current frame and the preset backlight value, and the correspondence buffered may be used in a subsequent backlight adjustment process.

It may be understood that the terminal device may buffer a delivered backlight value after the terminal device delivers the backlight value regardless of whether the new backlight value is replaced with the preset backlight value, and use the delivered backlight value as “backlight of a previous frame”, that is, as a determining criterion, in a next backlight adjustment process.

Based on this, the terminal device may add the preset backlight value for transition between backlight adjustment performed by the terminal device based on the DC dimming strategy and the backlight adjustment performed by the terminal device based on the PWM dimming strategy, so that the backlight brightness is forced to pass through the preset backlight value, thereby implementing smooth transition of screen brightness.

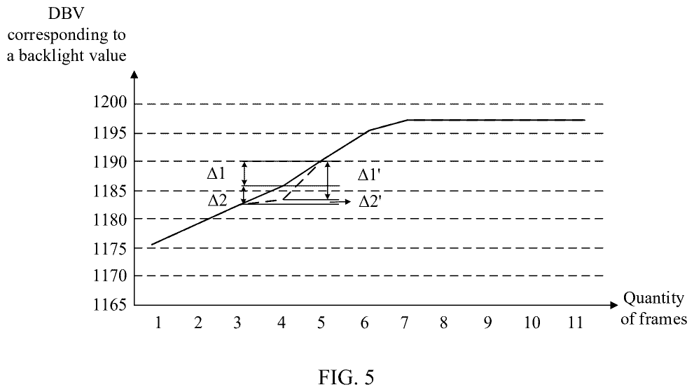

Based on the embodiment corresponding to FIG. 4, this embodiment of this application may describe a change situation of the backlight value before and after the backlight adjustment by using a backlight curve. For example, FIG. 5 is a schematic diagram of a backlight curve according to an embodiment of this application.

As shown in the schematic diagram of a backlight curve in FIG. 5, a horizontal coordinate may be a frame in which backlight takes effect, and a vertical coordinate may be a DBV corresponding to a backlight value.

From a third frame to a fifth frame, a solid line may be a first backlight curve formed by backlight values generated by the terminal device, and a dashed line may be a second backlight curve determined by the terminal device based on the backlight adjustment method described in the embodiment corresponding to FIG. 4. In addition, before the third frame and after the fifth frame, the first backlight curve may be the same as the second backlight curve.

For example, the terminal device may replace a backlight value corresponding to a fourth frame with the preset backlight value when the terminal device determines that a backlight value corresponding to the third frame passes through the preset backlight value and the backlight value corresponding to the third frame or the backlight value corresponding to the fourth frame is not 0, thereby implementing the smooth transition of the screen brightness by adding the preset backlight value used for transition.

The preset backlight value described in the embodiment corresponding to FIG. 5 may be a DBV corresponding to 75 nits, for example, 1184.

As shown in FIG. 5, Δ1 is less than Δ1′, and Δ2 is greater than Δ2′. Compared with the first backlight curve, adding the preset backlight value at the fourth frame may increase a backlight value difference between the fourth frame and the fifth frame, or increase a backlight value difference between the third frame and the fourth frame, which results in a stepped change in backlight.

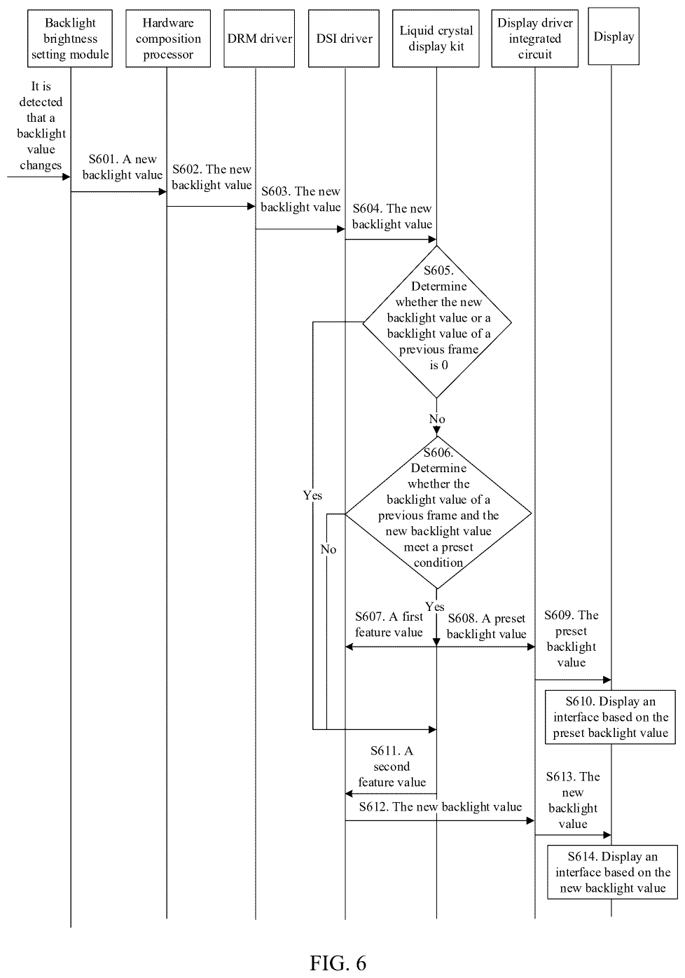

Based on the embodiment corresponding to FIG. 4, this application further provides a schematic diagram of module interaction in a backlight adjustment method. For specific interaction details, refer to an embodiment corresponding to FIG. 6.

For example, FIG. 6 is a schematic diagram of module interaction in a backlight adjustment method according to an embodiment of this application. In the embodiment corresponding to FIG. 6, the terminal device may include one or more of the following functional modules: a backlight brightness setting module, a hardware composition processor, a DRM driver, a DSI driver, a liquid crystal display kit, a display driver integrated circuit, or a display. The display may be an OLED or an LCD.

As shown in FIG. 6, the backlight adjustment method may include the following steps.

S601. The hardware composition processor obtains a new backlight value from the backlight brightness setting module when the backlight brightness setting module detects that a backlight value changes.

For a manner in which the backlight value changes, refer to the description in the step shown in S401. Details are not described herein again.

S602. The DRM driver obtains the new backlight value from the hardware composition processor.

S603. The DSI driver obtains the new backlight value from the DRM driver.

S604. The liquid crystal display kit obtains the new backlight value from the DSI driver.

S605. The liquid crystal display kit determines whether the new backlight value or a backlight value of a previous frame is 0.

The backlight value of a previous frame may be pre-buffered in the liquid crystal display kit.

The terminal device may perform steps shown in S611-S614 when the liquid crystal display kit determines that the new backlight value or the backlight value of a previous frame is 0 or the terminal device may perform a step shown in S606 when the liquid crystal display kit determines that the new backlight value is not 0 and the backlight value of a previous frame is not 0. For a process in which the liquid crystal display kit determines whether the new backlight value or the backlight value of a previous frame is 0, refer to the step shown in S402.

For example, the liquid crystal display kit may buffer a backlight value corresponding to each frame. When the backlight brightness setting module does not deliver the new backlight value within a period of time, it may be understood that the backlight value does not change within the period of time, and a plurality of backlight values stored in the liquid crystal display kit within the period of time may be the same.

S606. The liquid crystal display kit determines whether the backlight value of a previous frame and the new backlight value meet a preset condition.

The preset backlight value may be pre-stored in the liquid crystal display kit.

The liquid crystal display kit may perform steps shown in S607 and S608 when the liquid crystal display kit determines that the backlight value of a previous frame and the new backlight value meet the preset condition, or the liquid crystal display kit may perform steps shown in S611-S614 when the liquid crystal display kit determines that the backlight value of a previous frame and the new backlight value do not meet the preset condition. For a specific process in which the liquid crystal display kit determines whether the backlight value of a previous frame and the new backlight value meet the preset condition, refer to the step shown in S403.

S607. The DSI driver obtains a first feature value from the liquid crystal display kit.

The first feature value is used to indicate the DSI driver not to deliver the new backlight value. For example, the DSI driver may determine not to deliver the new backlight value to the display driver integrated circuit when the DSI driver receives the first feature value.

S608. The display driver integrated circuit obtains a preset backlight value from the liquid crystal display kit.

For example, the liquid crystal display kit may buffer the preset backlight value after the display driver integrated circuit obtains the preset backlight value from the liquid crystal display kit.

S607 and S608 may be performed synchronously or sequentially. This is not limited in this embodiment of this application.

In a possible implementation, after S606, the liquid crystal display kit may deliver the preset backlight value to the DSI driver when the liquid crystal display kit determines that the backlight value of a previous frame is greater than the preset backlight value, and the DSI driver continues to deliver the preset backlight value to the display driver integrated circuit. This is not limited in this embodiment of this application.

S609. The display obtains the preset backlight value from the display driver integrated circuit.

S610. The display displays an interface based on the preset backlight value.

S611. The DSI driver obtains a second feature value from the liquid crystal display kit.

The second feature value is used to indicate the DSI driver to deliver the new backlight value. For example, the DSI driver may determine to deliver the new backlight value to the display driver integrated circuit when the DSI driver receives the second feature value.

S612. The display driver integrated circuit obtains the new backlight value from the DSI driver.

S613. The display obtains the new backlight value from the display driver integrated circuit.

S614. The display displays an interface based on the new backlight value.

It may be understood that the liquid crystal display kit provided in this embodiment of this application may store the preset backlight value, determine a value between the backlight value of a previous frame and the preset backlight value, and deliver the preset backlight value. Therefore, backlight transition between the DC dimming strategy and the PWM dimming strategy is implemented based on the added preset backlight value, thereby implementing the smooth transition of the screen brightness.

### Method 2: Backlight Rollover Solution

In the backlight rollover solution, a terminal device may add a transition backlight value (or referred to as a preset backlight value) between a DC dimming strategy and a PWM dimming strategy, and may further implement rollover delivery of backlight, thereby implementing more stable backlight adjustment.

Based on the embodiments corresponding to FIG. 4 and FIG. 5, in a possible implementation, after the preset backlight value is delivered, there may be a case in which Δ1 is less than Δ1′ in FIG. 5, resulting in an increased difference between the backlight value of the fourth frame and the backlight value of the fifth frame, and leading to unstable backlight adjustment. Therefore, to adapt to more components, and to make the backlight adjustment more stable, an embodiment of this application further provides a backlight adjustment method.

For example, FIG. 7 is a schematic flowchart of another backlight adjustment method according to an embodiment of this application. As shown in FIG. 7, the backlight adjustment method may include the following steps.

S701. A terminal device obtains a new backlight value.

For a specific process in which the terminal device obtains the new backlight value, refer to the step shown in S401. Details are not described herein again.

S702. The terminal device determines whether the new backlight value or a backlight value of a previous frame is 0.

In this embodiment of this application, the terminal device may perform steps shown in S703-S704 when the terminal device determines that the new backlight value is 0 or the backlight value of a previous frame is 0 or the terminal device may perform a step shown in S705 when the terminal device determines that the new backlight value is not 0 and the backlight value of a previous frame is not 0.

For a specific step in which the terminal device determines whether the new backlight value or the backlight value of a previous frame is 0, refer to the step shown in S402 in FIG. 4. Details are not described herein again.

S703. The terminal device clears undelivered rollover backlight.

It may be understood that the terminal device may clear the undelivered rollover backlight because it is difficult to have a problem of an abrupt change in a screen-on ratio in a scenario in which the terminal device switches from a screen-on state to a screen-off state, switches from a screen-off state to a screen-on state, or is in a screen-off state. The rollover backlight may be backlight buffered in the terminal device after the terminal device does not deliver a current backlight value.

For example, when the terminal device determines to deliver a preset backlight value based on steps shown in S707-S708, the terminal device may determine a new backlight value that is not delivered currently as a rollover backlight value, and buffer the new backlight value.

S704. The terminal device displays an interface based on the new backlight value.

S705. The terminal device determines whether a quantity of undelivered rollover backlight is greater than 0.

In this embodiment of this application, the terminal device may perform a step shown in S706 when the terminal device determines that the quantity of undelivered rollover backlight is greater than 0 or the terminal device may perform a step shown in S707 when the terminal device determines that the quantity of undelivered rollover backlight is equal to 0.

S706. The terminal device displays an interface based on a rollover backlight value.

The rollover backlight value may be the first backlight value in the rollover backlight values described in S703.

It may be understood that, to implement stability of a backlight value, the terminal device may replace the new backlight value with the rollover backlight value after the terminal device delivers the rollover backlight value, and update a position of the new backlight value to the last position in the rollover backlight.

For example, the terminal device may obtain a third backlight value after the new backlight value. In addition, before it is determined to deliver the third backlight value and when the terminal device has already buffered the new backlight value, the terminal device may replace the third backlight value with the new backlight value and buffer the third backlight value. The buffered third backlight value may be used for delivery of a next backlight value.

S707. The terminal device determines whether the backlight value of a previous frame and the new backlight value meet a preset condition.

In this embodiment of this application, the terminal device may perform a step shown in S708 when the terminal device determines that the backlight value of a previous frame is greater than the preset backlight value or the terminal device may perform the step shown in S704 when the terminal device determines that the backlight value of a previous frame is less than or equal to the preset backlight value.

For a specific process in which the terminal device determines whether the backlight value of a previous frame is greater than the preset backlight value, refer to the step shown in S403. Details are not described herein again.

S708. The terminal device displays an interface based on the preset backlight value.

Based on this, the terminal device may maintain a backlight value difference between any two frames within a stable range through backlight value rollover, to implement stable delivery of the backlight value, thereby ensuring that a picture displayed by the terminal device in a backlight adjustment process better meets visual perception of a user.

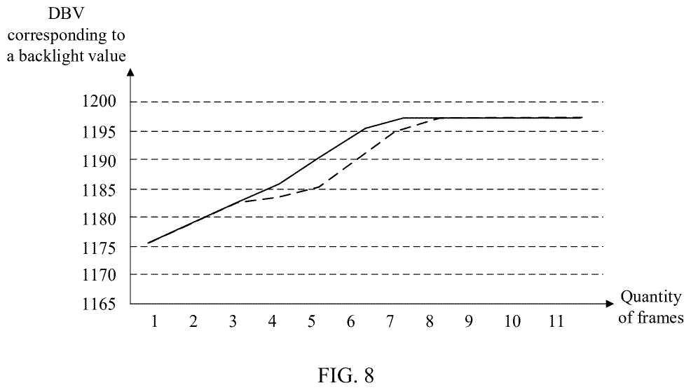

Based on the embodiment corresponding to FIG. 7, this embodiment of this application may describe a change situation of the backlight value before and after the backlight adjustment by using a backlight curve. For example, FIG. 8 is a schematic diagram of another backlight curve according to an embodiment of this application.

As shown in the schematic diagram of a backlight curve in FIG. 8, a horizontal coordinate may be a frame in which backlight takes effect, and a vertical coordinate may be a DBV corresponding to a backlight value.

From a third frame to an eighth frame, a solid line may be a first backlight curve formed by backlight values generated by the terminal device, and a dashed line may be a third backlight curve determined by the terminal device based on the backlight adjustment method described in the embodiment corresponding to FIG. 7. In addition, before the third frame and after the eighth frame, the first backlight curve may be the same as the third backlight curve.

For example, a fourth frame in the third backlight curve may be the preset backlight value delivered based on the embodiment corresponding to FIG. 7 or FIG. 4; a backlight value of a fifth frame in the third backlight curve may be the same as a backlight value of a fourth frame in the first backlight curve, a backlight value of a sixth frame in the third backlight curve may be the same as a backlight value of a fifth frame in the first backlight curve, a backlight value of a seventh frame in the third backlight curve may be the same as a backlight value of a sixth frame in the first backlight curve, and a backlight value of the eighth frame in the third backlight curve may be the same as the backlight value of the sixth frame in the first backlight curve.

It may be understood that the terminal device may maintain the backlight value difference between any two frames within the stable range through backlight value rollover, thereby ensuring that the picture displayed by the terminal device during the backlight adjustment process better meets visual perception of the user.

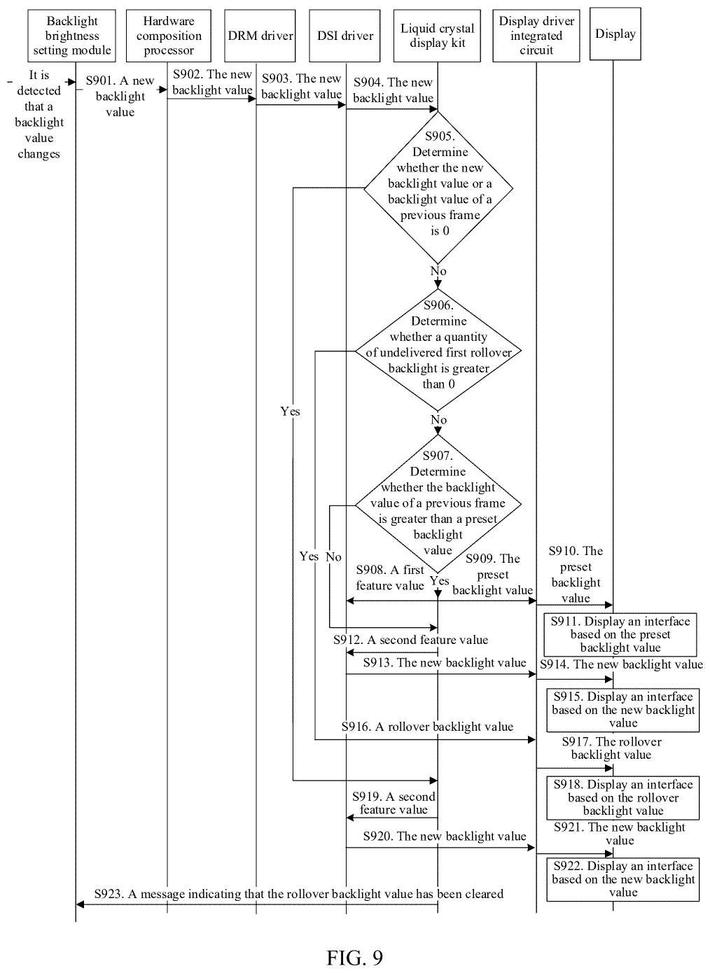

Based on the embodiment corresponding to FIG. 7, this application further provides a schematic diagram of module interaction in a backlight adjustment method. For specific interaction details, refer to an embodiment corresponding to FIG. 9.

For example, FIG. 9 is a schematic diagram of module interaction in another backlight adjustment method according to an embodiment of this application. In the embodiment corresponding to FIG. 9, the terminal device may include one or more of the following functional modules: a backlight brightness setting module, a hardware composition processor, a DRM driver, a DSI driver, a liquid crystal display kit, a display driver integrated circuit, or a display. The display may be an OLED or an LCD.

As shown in FIG. 9, the backlight adjustment method may include the following steps.

S901. The hardware composition processor obtains a new backlight value from the backlight brightness setting module when the backlight brightness setting module detects that a backlight value changes.

For a manner in which the backlight value changes, refer to the description in the step shown in S401. Details are not described herein again.

S902. The DRM driver obtains the new backlight value from the hardware composition processor.

S903. The DSI driver obtains the new backlight value from the DRM driver.

S904. The liquid crystal display kit obtains the new backlight value from the DSI driver.

S905. The liquid crystal display kit determines whether the new backlight value or a backlight value of a previous frame is 0.

The backlight value of a previous frame may be pre-buffered in the liquid crystal display kit.

The terminal device may perform steps shown in S919-S925 when the liquid crystal display kit determines that the new backlight value or the backlight value of a previous frame is 0 or the terminal device may perform a step shown in S906 when the liquid crystal display kit determines that the new backlight value is not 0 and the backlight value of a previous frame is not 0. For a process in which the liquid crystal display kit determines whether the new backlight value or the backlight value of a previous frame is 0, refer to the step shown in S402.

S906. The liquid crystal display kit determines whether a quantity of undelivered rollover backlight is greater than 0.

The rollover backlight may be pre-buffered in the liquid crystal display kit.

The terminal device may perform steps shown in S916-S918 when the liquid crystal display kit determines that the quantity of undelivered rollover backlight is greater than 0 or the terminal device may perform a step shown in S907 when the liquid crystal display kit determines that the quantity of undelivered rollover backlight is equal to 0.

S907. The liquid crystal display kit determines whether the backlight value of a previous frame and the new backlight value meet a preset condition.

The liquid crystal display kit may perform steps shown in S908 and S909 when the liquid crystal display kit determines that the backlight value of a previous frame is greater than the preset backlight value or the liquid crystal display kit may perform steps shown in S912-S915 when the liquid crystal display kit determines that the backlight value of a previous frame is less than or equal to the preset backlight value. For a specific process in which the liquid crystal display kit determines whether the backlight value of a previous frame is greater than the preset backlight value, refer to the step shown in S403.

S908. The DSI driver obtains a first feature value from the liquid crystal display kit.

For a meaning of the first feature value, refer to the step shown in S607. Details are not described herein again.

S909. The display driver integrated circuit obtains the preset backlight value from the liquid crystal display kit.

For example, the liquid crystal display kit may buffer the preset backlight value after the display driver integrated circuit obtains the preset backlight value from the liquid crystal display kit.

S910. The display obtains the preset backlight value from the display driver integrated circuit.

S911. The display displays an interface based on the preset backlight value.

S912. The DSI driver obtains a second feature value from the liquid crystal display kit.

For a meaning of the second feature value, refer to the step shown in S611. Details are not described herein again.

S913. The display driver integrated circuit obtains the new backlight value from the DSI driver.

S914. The display obtains the new backlight value from the display driver integrated circuit.

S915. The display displays an interface based on the new backlight value.

S916. The display driver integrated circuit obtains a rollover backlight value from the liquid crystal display kit.

For example, the liquid crystal display kit may buffer the rollover backlight value after the display driver integrated circuit obtains the rollover backlight value from the liquid crystal display kit.

S917. The display driver integrated circuit obtains the rollover backlight value from the DSI driver.

S918. The display obtains the rollover backlight value from the display driver integrated circuit.

S919. The DSI driver obtains a second feature value from the liquid crystal display kit.

For a meaning of the second feature value, refer to the step shown in S611. Details are not described herein again.

S920. The display driver integrated circuit obtains the new backlight value from the DSI driver.

S921. The display obtains the new backlight value from the display driver integrated circuit.

S922. The display displays an interface based on the new backlight value.

S923. The liquid crystal display kit sends a message indicating clearing of the rollover backlight value to the backlight brightness setting module.

For example, the liquid crystal display kit may delete the buffered rollover backlight value, and the liquid crystal display kit may send a message indicating that the rollover backlight value has already been cleared to the backlight brightness setting module by using modules such as the DSI driver, the DRM driver, and the hardware composition processor.

The steps shown in S919 and S923 may be performed synchronously or sequentially. This is not limited in this embodiment of this application.

With reference to the description in the embodiments corresponding to the method 1 and the method 2, it may be understood that this application may capture a DC-PWM transition scenario of the backlight by monitoring a unified backlight value delivery interface, and implement an actual effect of correcting a backlight curve that does not pass through a DC-PWM transition point to a backlight curve that passes through the DC-PWM transition point.

The backlight adjustment method provided in the embodiments of this application may be applied to any terminal device that supports a high-frequency PWM dimming panel and whose DDIC cannot support an autonomous pulse switching manner, for example, a display screen, a laptop, a tablet computer, or a mobile phone terminal.

It should be noted that user information (including but not limited to user equipment information, user personal information, and the like) and data (including but not limited to data used for analysis, stored data, displayed data, and the like) involved in this application are all information and data that are authorized by the user or that are fully authorized by each party. In addition, collection, use, and processing of the related data need to comply with relevant laws, regulations, and standards, and a corresponding operation entry is provided for the user to choose to authorize or reject.

With reference to the descriptions in the embodiments corresponding to FIG. 4-FIG. 9, an embodiment of this application provides a schematic flowchart of still another backlight adjustment method. The backlight adjustment method may include the following steps.

S1001. A terminal device displays an nth image frame.

A backlight value of the terminal device is a first backlight value when the nth image frame is displayed.

S1002. The terminal device displays an (n+1)th image frame.

A backlight value of the terminal device is a preset backlight value when the (n+1)th image frame is displayed.

The terminal device further obtains a second backlight value after displaying the nth image frame and before displaying the (n+1)th image frame, and when the second backlight value is not equal to the first backlight value, the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value, and displays the (n+1)th image frame based on the preset backlight value.

The second backlight value may be the new backlight value described in the embodiments of this application, and the first backlight value may be the backlight value of a previous frame described in the embodiments of this application.

The preset backlight value belongs to a preset backlight interval, a minimum value of the preset backlight interval is a minimum backlight value that is allowed to be adjusted when backlight adjustment is performed by using a direct current DC dimming strategy, and a maximum value of the preset backlight interval is a maximum backlight value that is allowed to be adjusted when backlight adjustment is implemented by using a pulse width modulation PWM dimming strategy.

In this way, the terminal device may add transition backlight during transition between the DC dimming strategy and the PWM dimming strategy, so that a problem of an abrupt change in screen brightness can be alleviated, thereby implementing smooth transition of the screen brightness.

In a possible implementation, that the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value includes: The terminal device replaces the second backlight value with the preset backlight value if the second backlight value is not 0 and the first backlight value is not 0 and if the second backlight value is greater than the preset backlight value and the first backlight value is less than the preset backlight value or the second backlight value is less than the preset backlight value and the first backlight value is greater than the preset backlight value.

In a possible implementation, the method further includes: The terminal device displays an interface based on the second backlight value if the second backlight value is 0 or the first backlight value is 0.

In a possible implementation, the method further includes: The terminal device buffers the second backlight value; and the terminal device displays an (n+2)th image frame, where a backlight value of the terminal device is the second backlight value when the (n+2)th image frame is displayed; and the terminal device further obtains a third backlight value after displaying the (n+1)th image frame and before displaying the (n+2)th image frame, and the terminal device buffers the third backlight value if the second backlight value is not 0, and displays the (n+2)th image frame based on the second backlight value.

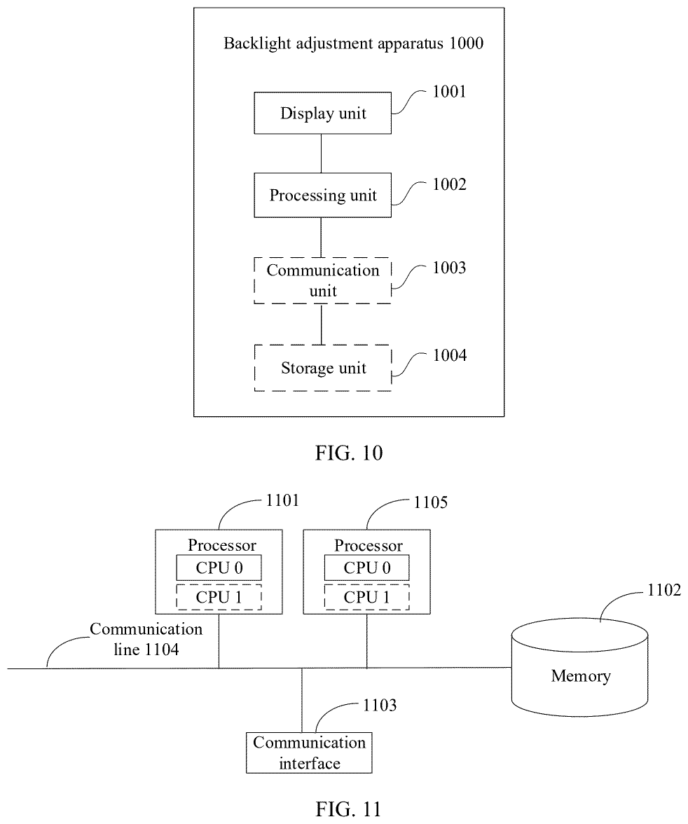

With reference to FIG. 4-FIG. 9, the method provided in embodiments of this application is described above. An apparatus provided in an embodiment of this application for performing the method is described below. As shown in FIG. 10, FIG. 10 is a schematic diagram of a structure of a synchronous playing apparatus according to an embodiment of this application. The synchronous playing apparatus may be a terminal device in the embodiments of this application, or may be a chip or a chip system in the terminal device.

As shown in FIG. 10, a backlight adjustment apparatus 1000 may be used in a communication device, a circuit, a hardware component, or a chip, and the backlight adjustment apparatus 1000 includes: an obtaining unit 1001 and a processing unit 1002. The obtaining unit 1001 is configured to support a backlight adjustment method in performing a step of obtaining information. The processing unit 1002 is configured to support the backlight adjustment apparatus 1000 in performing a step of processing the information.

In a possible implementation, the backlight adjustment apparatus 1000 may further include a communication unit 1003. The communication unit 1003 is configured to support the backlight adjustment apparatus 1000 in performing a step of receiving a message, a step of sending a message, or the like.

Specifically, the processing unit 1002 may be integrated with the obtaining unit 1001, and the processing unit 1002 and the obtaining unit 1001 may communicate with each other.

In a possible implementation, the backlight adjustment apparatus 1000 may further include: a storage unit 1004. The storage unit 1004 may include one or more memories, and the memory may be a component configured to store a program or data in one or more devices or circuits.

The storage unit 1004 may exist independently, and is connected to the processing unit 1002 by using a communication bus. Alternatively, the storage unit 1004 may be integrated with the processing unit 1002.

For example, the backlight adjustment apparatus 1000 may be the chip or the chip system in the terminal device in the embodiments of this application, and the storage unit 1004 may store computer-executable instructions of the method in the terminal device, so that the processing unit 1002 performs the method in the terminal device in the foregoing embodiments. The storage unit 1004 may be a register, a buffer, a random access memory (random access memory, RAM), or the like, and the storage unit 1004 may be integrated with the processing unit 1002. The storage unit 1004 may be a read-only memory (read-only memory, ROM) or another type of static storage device that can store static information and instructions. The storage unit 1004 may be independent of the processing unit 1002.

In a possible implementation, the backlight adjustment apparatus 1000 may further include a communication unit 1003. The communication unit 1003 is configured to support the backlight adjustment apparatus 1000 in interacting with another device. For example, the communication unit 1003 may be a communication interface or an interface circuit when the backlight adjustment apparatus 1000 is the terminal device. The communication unit 1003 may be the communication interface when the backlight adjustment apparatus 1000 is the chip or the chip system in the terminal device. For example, the communication interface may be an input/output interface, a pin, a circuit, or the like.

The apparatus in this embodiment may correspondingly be configured to perform the steps performed in the foregoing method embodiments. Implementation principles and technical effects of the apparatus and the foregoing method embodiments are similar and are not described herein again.

FIG. 11 is a schematic diagram of a hardware structure of another terminal device according to an embodiment of this application. As shown in FIG. 11, the terminal device may be a first device or a second device described in embodiments of this application.

The terminal device may include a processor 1101, a communication line 1104, and at least one communication interface (for example, a communication interface 1103 is used as an example for description in FIG. 11).

The processor 1101 may be a general-purpose central processing unit (central processing unit, CPU), a microprocessor, an application-specific integrated circuit (application-specific integrated circuit, ASIC), or one or more integrated circuits for controlling program execution in the solutions in this application.

The communication line 1104 may include a circuit for transmitting information among the foregoing components.

The communication interface 1103 uses any apparatus such as a transceiver and is configured to communicate with another device or a communication network, for example, an Ethernet or a wireless local area network (wireless local area networks, WLAN).

Possibly, the terminal device may further include a memory 1102.

The memory 1102 may be a read-only memory (read-only memory, ROM) or another type of static storage device capable of storing static information and instructions, a random access memory (random access memory, RAM) or another type of dynamic storage device capable of storing information and instructions, or an electrically erasable programmable read-only memory (electrically erasable programmable read-only memory, EEPROM), a compact disc read-only memory (compact disc read-only memory, CD-ROM) or another optical disc memory, a compact disc memory (including a compact disc, a laser disc, an optical disc, a digital versatile disc, a Blu-ray disc, and the like), a magnetic disk storage medium or another magnetic storage device, or any other medium that can be used to carry or store desired program code in the form of instructions or data structures and that can be accessed by a computer, but is not limited thereto. The memory may exist independently, and is connected to the processor by using the communication line 1104. The memory may alternatively be integrated with the processor.

The memory 1102 is configured to store computer-executable instructions for performing the solution in this application, and the processor 1101 controls execution. The processor 1101 is configured to execute the computer-executable instructions stored in the memory 1102, to implement the method provided in the embodiments of this application.

Possibly, the computer-executable instructions in this embodiment of this application may also be referred to as application code. This is not specifically limited in this embodiment of this application.

During specific implementation, in an embodiment, the processor 1101 may include one or more CPUs, for example, a CPU 0 and a CPU 1 in FIG. 11.

During specific implementation, in an embodiment, the terminal device may include a plurality of processors, for example, the processor 1101 and a processor 1105 in FIG. 11. Each of these processors may be a single-core (single-CPU) processor or a multi-core (multi-CPU) processor. The processor herein may be one or more devices, circuits, and/or processing cores configured to process data (for example, computer program instructions).

In the foregoing embodiments, the instructions stored in the memory for execution by the processor may be implemented in a form of a computer program product. The computer program product may be written in the memory in advance, or may be downloaded and installed in the memory in a form of software.

The computer program product includes one or more computer instructions. When the computer program instructions are loaded and executed on a computer, all or some of the procedures or functions according to the embodiments of this application are generated. The computer may be a general-purpose computer, a dedicated computer, a computer network, or another programmable apparatus. The computer instructions may be stored in a computer-readable storage medium or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) manner or a wireless (for example, infrared, radio, or microwave) manner. The computer-readable storage medium may be any available medium accessible by the computer, or a data storage device such as a server or a data center integrating one or more available media. For example, the available medium may include a magnetic medium (for example, a floppy disk, a hard disk, or a magnetic tape), an optical medium (for example, a digital versatile disc (digital versatile disc, DVD)), a semiconductor medium (for example, a solid state disk (solid state disk, SSD)), or the like.

An embodiment of this application further provides a computer-readable storage medium. All or some of the methods described in the foregoing embodiments may be implemented by using software, hardware, firmware, or any combination thereof. The computer-readable medium may include a computer storage medium and a communication medium, and may further include any medium that enables a computer program to be transmitted from a place to another place. The storage medium may be any target medium accessible by a computer.

In a possible design, the computer-readable medium may include a compact disc read-only memory (compact disc read-only memory, CD-ROM), a RAM, a ROM, an EEPROM, or another optical disc memory; and the computer-readable medium may include a magnetic disk memory or another magnetic disk storage device. In addition, any connection line may also be appropriately referred to as a computer-readable medium. For example, if software is transmitted from a website, a server, or another remote source by using a coaxial cable, an optical fiber cable, a twisted pair, a DSL, or a wireless technology (for example, infrared, radio, and microwave), the coaxial cable, the optical fiber cable, the twisted pair, the DSL, or the wireless technology such as infrared, radio, and microwave are included in the definition of the medium. As used herein, a magnetic disk and an optical disc include a compact disc (CD), a laser disc, an optical disc, a digital versatile disc (digital versatile disc, DVD), a floppy disk, and a Blu-ray disc. The magnetic disk usually reproduces data in a magnetic manner, and the optical disc reproduces data optically by using laser.

The foregoing combinations should also be included in the scope of the computer-readable medium. The foregoing descriptions are merely specific implementations of the present invention. However, the protection scope of the present invention is not limited thereto. Any change or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A backlight adjustment method, wherein the method comprises:
displaying, by a terminal device, an nth image frame, wherein a backlight value of the terminal device is a first backlight value when the nth image frame is displayed; and
displaying, by the terminal device, an (n+1)th image frame, wherein a backlight value of the terminal device is a preset backlight value when the (n+1)th image frame is displayed;
the terminal device further obtains a second backlight value after displaying the nth image frame and before displaying the (n+1)th image frame, and when the second backlight value is not equal to the first backlight value, the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value, and displays the (n+1)th image frame based on the preset backlight value; and
the preset backlight value belongs to a preset backlight interval, a minimum value of the preset backlight interval is a minimum backlight value that is allowed to be adjusted to when backlight adjustment is performed by using a direct current (DC) dimming strategy, and a maximum value of the preset backlight interval is a maximum backlight value that is allowed to be adjusted to when backlight adjustment is implemented by using a pulse width modulation (PWM) dimming strategy.

2. The method according to claim 1, wherein that the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value comprises:
replacing, by the terminal device, the second backlight value with the preset backlight value if the second backlight value is not 0 and the first backlight value is not 0 and if the second backlight value is greater than the preset backlight value and the first backlight value is less than the preset backlight value or the second backlight value is less than the preset backlight value and the first backlight value is greater than the preset backlight value.

3. The method according to claim 2, wherein the method further comprises:
displaying, by the terminal device, an interface based on the second backlight value if the second backlight value is 0 or the first backlight value is 0.

4. The method according to claim 1, wherein the method further comprises:
buffering, by the terminal device, the second backlight value; and
displaying, by the terminal device, an (n+2)th image frame, wherein a backlight value of the terminal device is the second backlight value when the (n+2)th image frame is displayed; and
the terminal device further obtains a third backlight value after displaying the (n+1)th image frame and before displaying the (n+2)th image frame, and the terminal device buffers the third backlight value if the second backlight value is not 0, and displays the (n+2)th image frame based on the second backlight value.

5. The method according to claim 1, wherein the terminal device comprises: a liquid crystal display kit and a display driver integrated circuit, and that the terminal device replaces the second backlight value with the preset backlight value, and displays an interface based on the preset backlight value comprises:
replacing, by the liquid crystal display kit, the second backlight value with the preset backlight value, and delivering the preset backlight value to the display driver integrated circuit; and
delivering, by the display driver integrated circuit, the preset backlight value to a display, and displaying, by the display, the interface based on the preset backlight value.

6. The method according to claim 5, wherein the terminal device further comprises a DSI driver, and the method further comprises:
delivering, by the liquid crystal display kit, a first feature value to the DSI driver; and
not delivering, by the DSI driver, the second backlight value based on the first feature value.

7. The method according to claim 3, wherein the terminal device comprises: a liquid crystal display kit, a DSI driver, and a display driver integrated circuit, and the displaying, by the terminal device, an interface based on the second backlight value if the second backlight value is 0 or the first backlight value is 0 comprises:
delivering, by the liquid crystal display kit, a second feature value to the DSI driver if the liquid crystal display kit determines that the second backlight value is 0 or the first backlight value is 0;
delivering, by the DSI driver, the second backlight value to the display driver integrated circuit based on the second feature value; and
delivering, by the display driver integrated circuit, the second backlight value to a display, and displaying, by the display, the interface based on the second backlight value.

8. The method according to claim 1, wherein the terminal device is a terminal device supporting a high-frequency PWM dimming strategy of 3840 Hz.

9. A terminal device, comprising a memory, a processor, and a computer program that is stored in the memory and that is capable of running on the processor, wherein when the processor executes the computer program, the terminal device is enabled to perform a backlight adjustment method, wherein the method comprises:
displaying, by the terminal device, an nth image frame, wherein a backlight value of the terminal device is a first backlight value when the nth image frame is displayed; and
displaying, by the terminal device, an (n+1)th image frame, wherein a backlight value of the terminal device is a preset backlight value when the (n+1)th image frame is displayed;
the terminal device further obtains a second backlight value after displaying the nth image frame and before displaying the (n+1)th image frame, and when the second backlight value is not equal to the first backlight value, the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value, and displays the (n+1)th image frame based on the preset backlight value; and
the preset backlight value belongs to a preset backlight interval, a minimum value of the preset backlight interval is a minimum backlight value that is allowed to be adjusted to when backlight adjustment is performed by using a direct current (DC) dimming strategy, and a maximum value of the preset backlight interval is a maximum backlight value that is allowed to be adjusted to when backlight adjustment is implemented by using a pulse width modulation (PWM) dimming strategy.

10. The terminal device according to claim 9, wherein that the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value comprises:
replacing, by the terminal device, the second backlight value with the preset backlight value if the second backlight value is not 0 and the first backlight value is not 0 and if the second backlight value is greater than the preset backlight value and the first backlight value is less than the preset backlight value or the second backlight value is less than the preset backlight value and the first backlight value is greater than the preset backlight value.

11. The terminal device according to claim 10, wherein the terminal device displaying an interface based on the second backlight value if the second backlight value is 0 or the first backlight value is 0.

12. The terminal device according to claim 9, wherein the method further comprises:
buffering, by the terminal device, the second backlight value; and
displaying, by the terminal device, an (n+2)th image frame, wherein a backlight value of the terminal device is the second backlight value when the (n+2)th image frame is displayed; and
the terminal device further obtains a third backlight value after displaying the (n+1)th image frame and before displaying the (n+2)th image frame, and the terminal device buffers the third backlight value if the second backlight value is not 0, and displays the (n+2)th image frame based on the second backlight value.

13. The terminal device according to claim 9, wherein the terminal device comprises: a liquid crystal display kit and a display driver integrated circuit, and that the terminal device replaces the second backlight value with the preset backlight value, and displays an interface based on the preset backlight value comprises:
replacing, by the liquid crystal display kit, the second backlight value with the preset backlight value, and delivering the preset backlight value to the display driver integrated circuit; and
delivering, by the display driver integrated circuit, the preset backlight value to a display, and displaying, by the display, the interface based on the preset backlight value.

14. The terminal device according to claim 13, wherein the terminal device further comprises a DSI driver, and the method further comprises:
delivering, by the liquid crystal display kit, a first feature value to the DSI driver; and
not delivering, by the DSI driver, the second backlight value based on the first feature value.

15. The terminal device according to claim 11, wherein the terminal device comprises: a liquid crystal display kit, a DSI driver, and a display driver integrated circuit, and the displaying, by the terminal device, an interface based on the second backlight value if the second backlight value is 0 or the first backlight value is 0 comprises:
delivering, by the liquid crystal display kit, a second feature value to the DSI driver if the liquid crystal display kit determines that the second backlight value is 0 or the first backlight value is 0;
delivering, by the DSI driver, the second backlight value to the display driver integrated circuit based on the second feature value; and
delivering, by the display driver integrated circuit, the second backlight value to a display, and displaying, by the display, the interface based on the second backlight value.

16. The terminal device according to claim 9, wherein the terminal device is a terminal device supporting a high-frequency PWM dimming strategy of 3840 Hz.

17. A computer-readable storage medium, wherein the computer-readable storage medium stores a computer program, and when the computer program is executed by a processor, a computer is enabled to perform a backlight adjustment method, wherein the method comprises:
displaying, by a terminal device, an nth image frame, wherein a backlight value of the terminal device is a first backlight value when the nth image frame is displayed; and
displaying, by the terminal device, an (n+1)th image frame, wherein a backlight value of the terminal device is a preset backlight value when the (n+1)th image frame is displayed;
the terminal device further obtains a second backlight value after displaying the nth image frame and before displaying the (n+1)th image frame, and when the second backlight value is not equal to the first backlight value, the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value, and displays the (n+1)th image frame based on the preset backlight value; and
the preset backlight value belongs to a preset backlight interval, a minimum value of the preset backlight interval is a minimum backlight value that is allowed to be adjusted to when backlight adjustment is performed by using a direct current (DC) dimming strategy, and a maximum value of the preset backlight interval is a maximum backlight value that is allowed to be adjusted to when backlight adjustment is implemented by using a pulse width modulation (PWM) dimming strategy.

18. The computer-readable storage medium according to claim 17, wherein that the terminal device replaces the second backlight value with the preset backlight value if the second backlight value is greater than the preset backlight value and the first backlight value is less than the preset backlight value or if the second backlight value is less than the preset backlight value and the first backlight value is greater than the preset backlight value comprises:
replacing, by the terminal device, the second backlight value with the preset backlight value if the second backlight value is not 0 and the first backlight value is not 0 and if the second backlight value is greater than the preset backlight value and the first backlight value is less than the preset backlight value or the second backlight value is less than the preset backlight value and the first backlight value is greater than the preset backlight value.

19. The computer-readable storage medium according to claim 18, wherein the method further comprises:
displaying, by the terminal device, an interface based on the second backlight value if the second backlight value is 0 or the first backlight value is 0.

20. The computer-readable storage medium according to claim 17, wherein the method further comprises:
buffering, by the terminal device, the second backlight value; and
displaying, by the terminal device, an (n+2)th image frame, wherein a backlight value of the terminal device is the second backlight value when the (n+2)th image frame is displayed; and
the terminal device further obtains a third backlight value after displaying the (n+1)th image frame and before displaying the (n+2)th image frame, and the terminal device buffers the third backlight value if the second backlight value is not 0, and displays the (n+2)th image frame based on the second backlight value.
